(19) United States
(12) Patent Application Publication
(10) Pub. No.: US 2024/0391502 A1
(43) Pub. Date: Nov. 28, 2024

(54) GAME-AWARE MODE ENUMERATION AND UNDERSTANDING FOR TRAJECTORY PREDICTION

(71) Applicants: Toyota Research Institute, Inc., Los Altos, CA (US); The Trustees of Princeton University, Princeton, NJ (US)

(72) Inventors: Guy Rosman, Newton, MA (US); Justin Lidard, Somerville, MA (US); Oswin So, Cambridge, MA (US); Yanxia Zhang, Foster City, CA (US); Paul M. Drews, Watertown, MA (US); Jonathan DeCastro, Arlington, MA (US); Xiongyi Cui, Somerville, MA (US); Yen-Ling Kuo, Charlottesville, VA (US); John J. Leonard, Newton, MA (US); Avinash Balachandran, Sunnyvale, CA (US); Naomi Ehrich Leonard, Princeton, NJ (US)

(73) Assignees: Toyota Research Institute, Inc., Los Altos, CA (US); Toyota Jidosha Kabushiki Kaisha, Toyota-shi (JP); The Trustees of Princeton University, Princeton, NJ (US)

(21) Appl. No.: 18/483,479

(22) Filed: Oct. 9, 2023

Related U.S. Application Data
(60) Provisional application No. 63/504,045, filed on May 24, 2023.

(51) Int. Cl. B60W 60/00

(52) U.S. Cl. CPC B60W 60/0027

(57) ABSTRACT

Systems and methods are provided trajectory prediction that leverages game-theory to improve coverage of multi-modal predictions. Examples of the systems and methods include obtaining training data including first trajectories for a first plurality of agent devices and first map information of a first environment for a past time horizon and applying the training data to a game-theoretic mode-finding algorithm to generate a mode-finding model for each agent device that predicts modes of the first trajectories. A trajectory prediction model can be trained on the predicted modes as a coverage loss term between predicted modes. Future trajectories can be predicted for a second plurality of agent devices based on applying observed data to the trajectory prediction model. A control signal can then be generated to effectuate an autonomous driving command on an agent device of the second plurality of agent devices based on the predicted future trajectories.

### CROSS-REFERENCE TO RELATED APPLICATIONS

This application claims the benefit of and priority to U.S. Provisional Application No. 63/504,045, filed on May 24, 2023, the contents of which is incorporated herein by reference in its entirety.

### TECHNICAL FIELD

The present disclosure relates generally to systems and methods for autonomous and semi-autonomous vehicle operation, and, more particularly, some embodiments relate to systems and methods that provide for multi-agent trajectory prediction through game-theory for multi-modal predictions.

### DESCRIPTION OF RELATED ART

Accurately predicting multi-agent trajectories can be an important task for autonomous driving systems, particularly in dense or urban environments. Interactions between agents can introduce multiple motion modalities through which future joint behaviors amongst the agents may diverge. Scenarios where agents are forced to interact and negotiate their future behavior can present a significant challenge for prediction by autonomous driving systems. For example, two agents may compete to merge before the other, or a group of agents may be forced to arbitrate right-of-way at a four-way stop. Such interactions, while intuitive for human drivers, can be difficult for autonomous driving systems to comprehend.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method for trajectory planning and/or prediction is provided. The method comprises obtaining training data including first trajectories for a first plurality of agent devices and first map information of a first environment for a past time horizon; applying the training data to a game-theoretic mode-finding algorithm to generate a mode-finding model for each agent device that predicts modes of the first trajectories; training a trajectory prediction model on the predicted modes as a coverage loss term between predicted modes; predicting future trajectories for a second plurality of agent devices based on applying observed data to the trajectory prediction model, wherein the observed data includes second trajectories for a second plurality of agent devices and second map information of a second environment; and generating a control signal to effectuate an autonomous driving command on an agent device of the second plurality of agent devices based on the predicted future trajectories.

In another aspect, a system is provided that comprises a memory configured to store instructions and one or more processors communicably coupled to the memory. The one or more processors are configured to execute the instructions to obtain training data including first trajectories for a first plurality of agent devices and first map information of a first environment for a past time horizon; train a trajectory prediction model on modes of the first trajectories predicted by a mode-finding model trained by applying the training data to a game-theoretic mode-finding algorithm; predict trajectories for a second plurality of agent devices based on applying observed data to the trajectory prediction model, wherein the observed data includes second trajectories for a second plurality of agent devices and second map information of a second environment; and generate a control signal to effectuate an autonomous driving command on an agent device of the second plurality of agent devices based on the predicted trajectories.

In another aspect, a non-transitory machine-readable medium is provided. The non-transitory computer-readable medium includes instructions that when executed by a processor cause the processor to perform operations including collecting observed trajectories for a plurality of agent devices and map information of an environment; predicting future trajectories for the plurality of agent devices based on weighted modes output by a game-theoretic mode-finding model trained to detect modes as groups of trajectories and assign weights to each mode; and generating an autonomous driving command for controlling an agent device of the plurality of agent devices based on the predicted future trajectories.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIGS. 1A and 1B illustrate an example of multi-agent trajectory prediction, where conventional and metrically diverse predictors fail to cover the distinct realistic motion modes that emerge from human behavioral reasoning.

FIG. 2 is a schematic representation of an example hybrid vehicle with which embodiments of the systems and methods disclosed herein may be implemented.

FIG. 3 illustrates an example architecture for multi-agent trajectory prediction in accordance with one embodiment of the systems and methods described herein.

FIG. 4 is an example network architecture of a multi-agent trajectory prediction system in accordance with various embodiments disclosed herein.

FIG. 5 is a schematic block diagram of an example architecture for trajectory prediction according to embodiments disclosed herein.

FIG. 6 illustrates an example mode optimization operation according to embodiments disclosed herein.

FIGS. 7A-7F illustrate example trajectories predicted by example implementations of the embodiments disclosed herein.

FIGS. 8A and 8B are box plots that show a tradeoff between accuracy and coverage as semantic complexity increases with the number of yield interactions for the experimental implementations disclosed herein.

FIG. 9A illustrates a tradeoff between accuracy and coverage.

FIGS. 9B and 9C are graphical representations of how samples contribute to accuracy and coverage.

FIG. 10 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide a framework for trajectory prediction that leverages game-theory to improve coverage of multi-modal predictions. The embodiments disclosed herein use a game-theoretic numerical analysis as an auxiliary loss during training phases, which results in improved prediction coverage of agent behaviors and predication accuracy without requiring presumptions on taxonomy of actions for the agents. Particularly, by leveraging game-theoretic numerical analysis, embodiments disclosed herein account for semantically distinct outcomes. For example, embodiments disclosed herein take historical agent trajectories and map information about a scene over a past time horizon and output a set of weighted trajectories that includes a series of multi-agent states for a time horizon. The embodiments disclosed herein use mode analysis under a bounded-rationality model to learn and reason over the game-theoretic reward landscape and encourage coverage of that landscape via auxiliary training costs, resulting in a general notion of task diversity with learned game-theoretic utilities in the multi-agent setting.

As alluded to above, interactions between road agents present a significant challenge in trajectory prediction for autonomous driving, especially in cases involving multiple agents. Conventional approaches to diversity-aware prediction do not account for the interactive nature of multi-agent predictions. As a result, conventional approaches miss these important interaction outcomes. Embodiments disclosed herein leverage game-theoretic aspects that provide for improvements over the conventional approaches, as noted above.

Game-theoretic aspects have been explored in planning within the dynamic games formulation. An optimal trajectory can be solved according to the best response of other agents in play. In other words, each agent optimizes a plan assuming some knowledge about the other agents' plans. However, this problem can be further complicated when an agent is attempting to predict other agents' behaviors, requiring coverage of all likely behaviors, as well as scenarios.

Some conventional approaches have sought to improve coverage of distinct outcomes in trajectory predictions, for example, by leveraging either metric diversity or specific semantics of actions and goals. In cases where diversity does not lend itself to a known taxonomy, such approaches suffer in the resulting prediction coverage. For example, these approaches relied on labeling distinct outcomes or coded specific filters for outcomes, semantically or otherwise, to train prediction models. Thus, these approaches are only capable of addressing a taxonomy of outcomes that were labeled or coded into the model.

Whereas, embodiments disclosed herein can be trained on a reward model learned from the historical trajectories and map information over a past time horizon. That is, for example, embodiments disclosed herein provide a reward function that can predict locally optimal outcomes on an agent-by-agent basis. As a result, embodiments disclosed herein can provide improved predication coverage without relying on metric dissimilarity or explicit semantic taxonomies (e.g., explicitly labeled, coded, or otherwise). To leverage this, embodiments of the disclosed technology provide a multi-modal prediction framework that learns a general utility model (e.g., value, sum-of-expected-rewards, or the like) for multi-agent decision-making, and leverages knowledge of multi-agent utilities to make diverse predictions in the space of utilities. According to some of the disclosed embodiments, the framework can use multi-mode analysis under a bounded-rationality model to learn and reason over a game-theoretic reward landscape, and encourage coverage of that landscape via auxiliary training costs. As a result, the outcome is a more general notion of task diversity with learned game-theoretic utilities in the multi-agent setting.

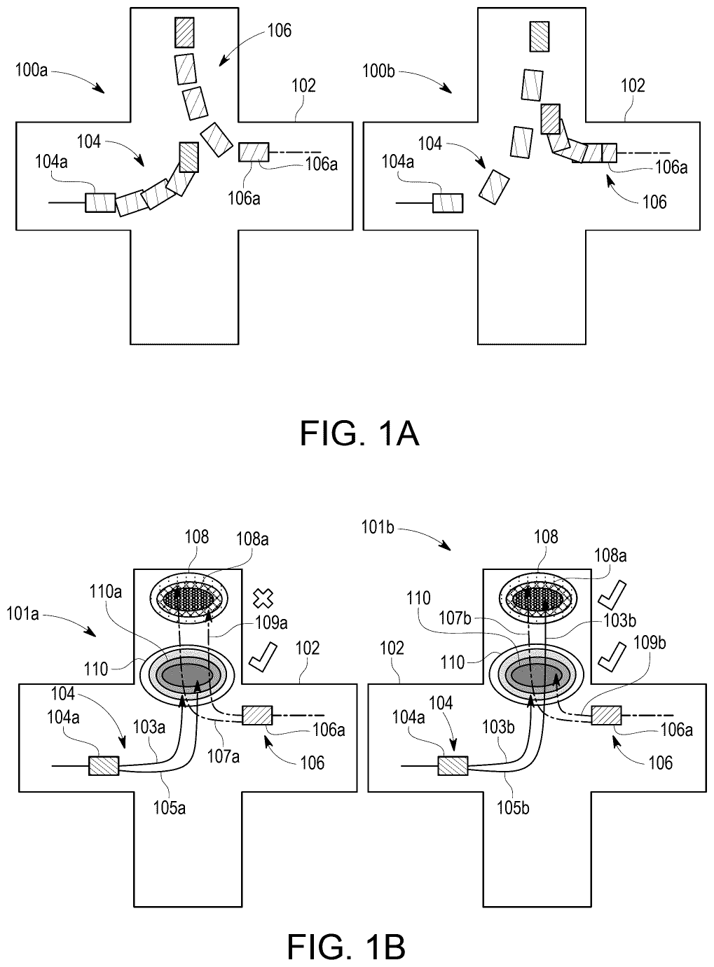

FIGS. 1A and 1B illustrate an example of multi-agent trajectory prediction, where conventional and metrically diverse predictors fail to cover the distinct realistic motion modes that emerge from human behavioral reasoning.

FIG. 1A illustrates two different possible trajectory rollouts 100a and 100b of a scene at an intersection 102 of a roadway environment. In each depiction, a first agent 104 and a second agent 106 approach the intersection at positions 104a and 106a, respectively, and attempt to arbitrate right-of-way between the two agents. In trajectory rollout 100a, first agent 104 yields to second agent 106 with both agents respecting standard right-of-way protocols. Whereas, trajectory rollout 100b depicts a scenario where second agent 106 suddenly yields to first agent 104 after first agent 104 ignores the oncoming second agent 106, thereby incurring lower payoff in terms of safety and acceleration costs (e.g., sudden braking as shown by the condensed spacing between positions of second agent 106).

Non-game-aware predictors as used in the conventional approaches struggle to capture the different outcomes. This is because covering distinct outcomes with a limited number of samples is a significant challenge in prediction. To increase coverage of distinct outcomes, conventional approaches employ several different strategies. Metrically diverse sampling methods adopt a sampling procedure to optimize some pairwise metric between trajectories, typically the 12-norm. While metric diversity increases the number of seemingly distinct motion modes, predictive accuracy may suffer as sampled trajectories may not have high likelihood. On the other hand, some approaches promote sample diversity instead by conditioning on a sampled latent semantic representation (e.g. “left turn” or “yield”), typically waypoints or maneuvers. This can afford exploration in the space of the latent representation, but such representations generally must be hand-labeled or learned from data. Moreover, these latent representations are static and may be difficult to classify in the presence of dynamic interactions, where waypoints and maneuvers are dependent on the actions of other agents (e.g. 4-way stop). The distinct outcomes of such interactions, while intuitive for human drivers, are neither captured by maneuver and waypoint choices, nor by the metric distance between trajectories.

The embodiments disclosed herein bridges this gap by providing a metric to score and rank trajectories using features available in the dataset during inference time, without depending only on metric distances or hand-labeled features. For example, game theory allows the embodiment disclosed herein to contrast different outcomes in trajectories as measured by a scalar reward signal and different values in the reward signal indicate different outcomes in the game. Given enough of these distinct outcomes, many different semantic scenarios can be covered.

FIG. 1B depicts multi-agent trajectory predictions 101a and 101b for the scene of FIG. 1A. In each trajectory prediction 101a and 101b, first agent 104 approaches position 104a and second agent 106 approaches position 106a and the trajectory predication attempts to predict distinct overall outcomes by predicating trajectories for each agent.

In each trajectory prediction 101a and 101b, distributions of motion modes 108 and 110 are provided having higher concentrations at the centers which represent higher-likelihood modes 108a and 110b and lower-likelihood mode distributions surrounding the higher-likelihood modes 108a and 110b. In multi-agent trajectory predictions 101a, a conventional predictor samples trajectories 103a and 105a for first agent 104, both of which are from a higher-likelihood mode 110a. However, the conventional predictor misses trajectories for first agent 104 for the lower likelihood mode. Similarly, the conventional predictor samples two trajectories 109a and 107a for second agent 106 relative to first agent 104 from the higher-likelihood mode 108a, but misses trajectories for the lower likelihood mode. Thus, a conventional predictor misses the lower-likelihood modes, even though these modes are still entirely possible.

Whereas, the game-aware predictor according to embodiments disclosed herein captures payoff diversity and finds trajectories for both modes for agents 104 and 106. Accordingly, embodiments disclosed herein, through leveraging of game-theoretic models, can be used to improve the coverage of prediction networks without presuming a maneuver taxonomy, beyond that provided by conventional metric trajectory coverage approaches. The embodiments disclosed herein reveal coverage of semantic interactions, lending into different modes of utility-driven decision-making.

As used herein, a “mode” refers to a local optimum in a trajectory landscape (or distribution). For example, a mode can represent either a single or class of trajectories such that similar trajectories can all be grouped together under a common metric. As an illustrative example, consider a single agent, driving modes can be turning left, turning right, going straight, etc. For multiple agents, the possibilities are more complex because all combinations of individual trajectories for each agent are considered.

As used herein, an “agent” refers to a moving body within a environment. An agent may refer to a vehicle, a pedestrian, a bicyclist, or any sort of moving body that may attempt to navigate the environment (e.g., roadway environment as shown in FIGS. 1A and 1B). An “agent device” refers to a computing device corresponding to an agent. An agent device may be, for example but not limited to, a smartphone, a desktop computer, a laptop computer, a tablet computer, a netbook computer, a personal digital assistant (PDA), a wearable smart device such as smartwatches and the like, a mobile phone, a smart phone, a smart terminal, a dumb terminal, and the like. In some embodiments, the agent device may be a computing component installed on a vehicle, for example, an electronic control unit or the like.

As used herein, the words “environment” and “geographic area,” refer to a physical space of a geographic location (e.g., an area of defined space surrounding a geographic location or position) in which one or more target agents are situated. As used herein, the word “scene” refers to an arrangement of agents and physical objects within an environment. A scene may be a result of a sequence of continuous actions performed by agents in an environment for a time horizon preceding a current time, resulting in a current arrangement of agents, relative to each other and to the environment.

According to embodiments disclosed herein, vehicles may operate in either a semi-autonomous or a fully autonomous driving mode. As used herein, “semi-autonomous driving mode” refers to an operation mode wherein an autonomous driving system receives inputs from a human driver, which may indicate the driver's desired path of travel. Based on the received driving inputs, the autonomous driving system may provide corrective assistance according to multi-agent trajectory predictions. For example, the autonomous driving system may provide steering corrections to maintain a vehicle in the center of a lane or move to a side of the lane based on multi-agent trajectory predictions. In other examples, the autonomous driving system may apply automatic braking in order to avoid/mitigate a collision based on multi-agent trajectory predictions. As used herein, “fully autonomous mode” or “autonomous mode” refers to a vehicle operation wherein the autonomous driving system has complete control over driving, without human driver input. Here, the autonomous driving system must determine/execute driving commands which track a desired trajectory that is based on multi-agent trajectory predictions.

It should be noted that the terms “optimize,” “optimal,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

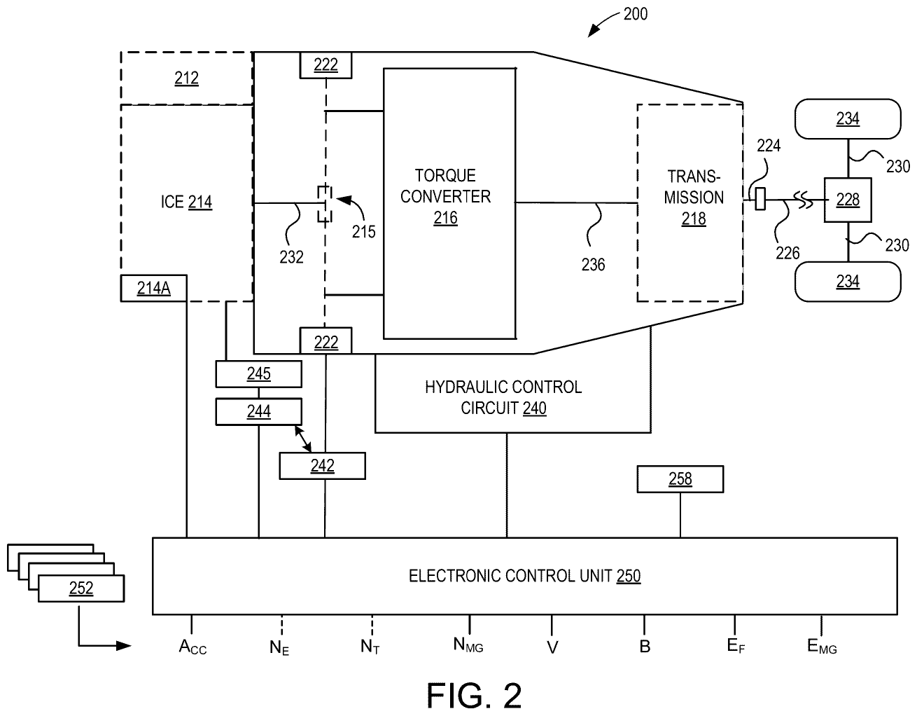

The systems and methods disclosed herein may be implemented with any of a number of different vehicles and vehicle types. For example, the systems and methods disclosed herein may be used with automobiles, trucks, motorcycles, recreational vehicles, and others like on- or off-road vehicles. In addition, the principals disclosed herein may also extend to other vehicle types as well. An example hybrid electric vehicle (HEV) in which embodiments of the disclosed technology may be implemented is illustrated in FIG. 2. Although the example described with reference to FIG. 2 is a hybrid type of vehicle, the systems and methods for multi-agent trajectory prediction can be implemented in other types of vehicle, including gasoline- or diesel-powered vehicles, fuel-cell vehicles, electric vehicles, or other vehicles.

FIG. 2 illustrates a drive system of an example vehicle 200 that may include an internal combustion engine 214 and one or more electric motors 222 (which may also serve as generators) as sources of motive power. Driving force generated by the internal combustion engine 214 and motors 222 can be transmitted to one or more wheels 234 via a torque converter 216, a transmission 218, a differential gear device 228, and a pair of axles 230.

As an HEV, vehicle 200 may be driven/powered with either or both of engine 214 and the motor(s) 222 as the drive source for travel. For example, a first travel mode may be an engine-only travel mode that only uses internal combustion engine 214 as the source of motive power. A second travel mode may be an EV travel mode that only uses the motor(s) 222 as the source of motive power. A third travel mode may be an HEV travel mode that uses engine 214 and the motor(s) 222 as the sources of motive power. In the engine-only and HEV travel modes, vehicle 200 relies on the motive force generated at least by internal combustion engine 214, and a clutch 215 may be included to engage engine 214. In the EV travel mode, vehicle 200 is powered by the motive force generated by motor(s) 222 while engine 214 may be stopped and clutch 215 disengaged.

Engine 214 can be an internal combustion engine such as a gasoline, diesel, or similarly powered engine in which fuel is injected into and combusted in a combustion chamber. A cooling system 212 can be provided to cool the engine 214 such as, for example, by removing excess heat from engine 214. For example, cooling system 212 can be implemented to include a radiator, a water pump, and a series of cooling channels. In operation, the water pump circulates coolant through the engine 214 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 214. In other applications, either or both the water pump and the fan may be operated by electric current such as from battery 244.

An output control circuit 214A may be provided to control drive (output torque) of engine 214. Output control circuit 214A may include a throttle actuator to control an electronic throttle valve that controls fuel injection, an ignition device that controls ignition timing, and the like. Output control circuit 214A may execute output control of engine 214 according to a control signal(s) supplied from an electronic control unit 250, described below. Such output control can include, for example, throttle control, fuel injection control, and ignition timing control.

Motor 222 can also be used to provide motive power in vehicle 200 and is powered electrically via a battery 244. Battery 244 may be implemented as one or more batteries or other power storage devices, including, for example, lead-acid batteries, nickel-metal hydride batteries, lithium ion batteries, capacitive storage devices, and so on. Battery 244 may be charged by a battery charger 245 that receives energy from internal combustion engine 214. For example, an alternator or generator may be coupled directly or indirectly to a drive shaft of internal combustion engine 214 to generate an electrical current as a result of the operation of internal combustion engine 214. A clutch can be included to engage/disengage the battery charger 245. Battery 244 may also be charged by motor 222 such as, for example, by regenerative braking or by coasting during which time motor 222 operates as a generator.

Motor 222 can be powered by battery 244 to generate a motive force to move the vehicle and adjust vehicle speed. Motor 222 can also function as a generator to generate electrical power such as, for example, when coasting or braking. Battery 244 may also be used to power other electrical or electronic systems in the vehicle. Motor 222 may be connected to battery 244 via an inverter 242. Battery 244 can include, for example, one or more batteries, capacitive storage units, or other storage reservoirs suitable for storing electrical energy that can be used to power motor 222. When battery 244 is implemented using one or more batteries, the batteries can include, for example, nickel metal hydride batteries, lithium ion batteries, lead-acid batteries, nickel cadmium batteries, lithium ion polymer batteries, and other types of batteries.

An electronic control unit 250 (described below) may be included and may control the electric drive components of the vehicle as well as other vehicle components. For example, electronic control unit 250 may control inverter 242, adjust driving current supplied to motor 222, and adjust the current received from motor 222 during regenerative coasting and breaking. As a more particular example, output torque of motor 222 can be increased or decreased by electronic control unit 250 through inverter 242.

A torque converter 216 can be included to control the application of power from engine 214 and motor 222 to transmission 218. Torque converter 216 can include a viscous fluid coupling that transfers rotational power from the motive power source to the driveshaft via the transmission. Torque converter 216 can include a conventional torque converter or a lockup torque converter. In other embodiments, a mechanical clutch can be used in place of torque converter 216.

Clutch 215 can be included to engage and disengage engine 214 from the drivetrain of the vehicle. In the illustrated example, a crankshaft 232, which is an output member of engine 214, may be selectively coupled to motor 222 and torque converter 216 via clutch 215. Clutch 215 can be implemented as, for example, a multiple disc type hydraulic frictional engagement device whose engagement is controlled by an actuator such as a hydraulic actuator. Clutch 215 may be controlled such that its engagement state is complete engagement, slip engagement, or complete disengagement, depending on the pressure applied to the clutch. For example, a torque capacity of clutch 215 may be controlled according to the hydraulic pressure supplied from a hydraulic control circuit (not illustrated). When clutch 215 is engaged, power transmission is provided in the power transmission path between crankshaft 232 and torque converter 216. On the other hand, when clutch 215 is disengaged, motive power from engine 214 is not delivered to torque converter 216. In a slip engagement state, clutch 215 is engaged, and motive power is provided to torque converter 216 according to a torque capacity (transmission torque) of clutch 215.

As alluded to above, vehicle 200 may include an electronic control unit 250. Electronic control unit 250 may include circuitry to control various aspects of the vehicle operation. Electronic control unit 250 may include, for example, a microcomputer that includes one or more processing units (e.g., microprocessors), memory storage (e.g., RAM, ROM, etc.), and I/O devices. The processing units of electronic control unit 250 execute instructions stored in memory to control one or more electrical systems or subsystems 258 in the vehicle. Electronic control unit 250 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 2, electronic control unit 250 receives information from a plurality of sensors included in vehicle 200. For example, electronic control unit 250 may receive signals that indicate vehicle operating conditions or characteristics, or signals that can be used to derive vehicle operating conditions or characteristics. These may include, but are not limited to, accelerator operation amount (A_{CC}), a revolution speed (N_{E}), of internal combustion engine 214 (engine RPM), a rotational speed (N_{MG}), of the motor 222 (motor rotational speed), and vehicle speed (V). These may also include torque converter 216 output (N_{T}) (e.g., output amps indicative of motor output), brake operation amount/pressure (B), battery SOC (i.e., the charged amount for battery 244 detected by an SOC sensor). Accordingly, vehicle 200 can include a plurality of sensors 252 that can be used to detect various conditions internal or external to the vehicle and provide sensed conditions to engine control unit 250 (which, again, may be implemented as one or a plurality of individual control circuits). In one embodiment, sensors 252 may be included to detect one or more conditions directly or indirectly such as, for example, fuel efficiency (E_{F}), motor efficiency (E_{MG}), hybrid (internal combustion engine 214+MG 222) efficiency, acceleration (A_{CC}), etc.

In some embodiments, one or more sensors 252 may include their own processing capability to compute the results for additional information that can be provided to electronic control unit 250. In other embodiments, one or more sensors 252 may be data-gathering-only sensors that provide only raw data to electronic control unit 250. In further embodiments, hybrid sensors may be included that provide a combination of raw data and processed data to electronic control unit 250. Sensors 252 may provide an analog output or a digital output.

Sensors 252 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 200, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 2 is provided for illustration purposes only as one example of vehicle systems with which embodiments of the disclosed technology may be implemented. One of ordinary skill in the art reading this description will understand how the disclosed embodiments can be implemented with this and other vehicle platforms.

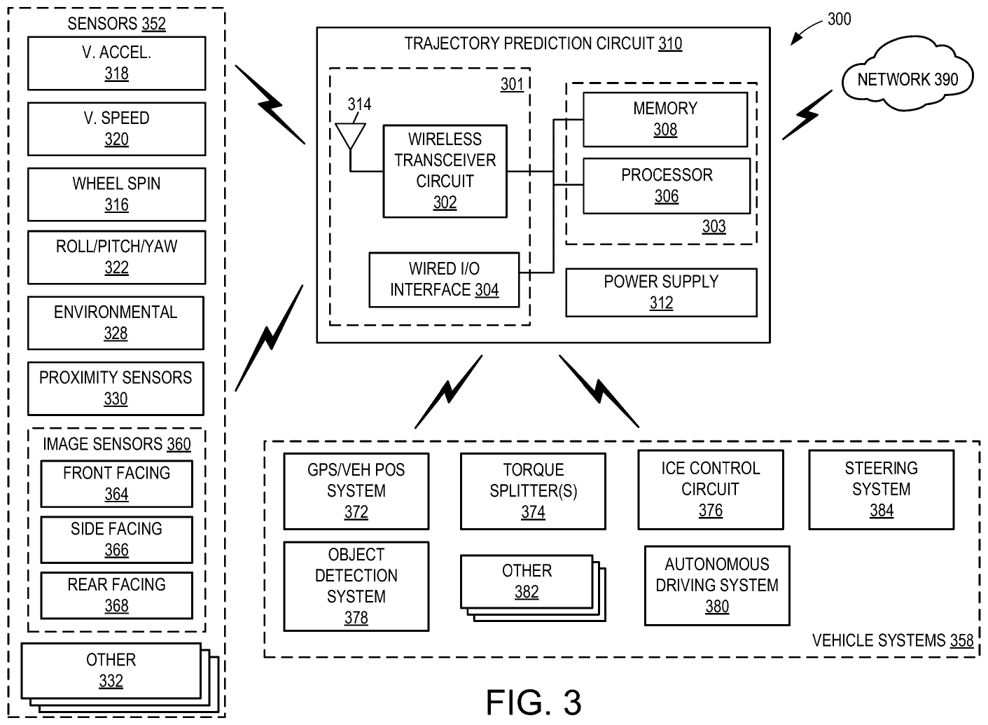

FIG. 3 illustrates an example architecture for multi-agent trajectory prediction in accordance with one embodiment of the systems and methods described herein. Referring now to FIG. 3, in this example, trajectory prediction system 300 includes a trajectory prediction circuit 310, a plurality of sensors 352, and a plurality of vehicle systems 358. Sensors 352 (such as sensors 252 described in connection with FIG. 2) and vehicle systems 358 (such as subsystems 258 described in connection with FIG. 2) can communicate with trajectory prediction circuit 310 via a wired or wireless communication interface. Although sensors 352 and vehicle systems 358 are depicted as communicating with trajectory prediction circuit 310, they can also communicate with each other as well as with other vehicle systems. Trajectory prediction circuit 310 can be implemented as an ECU or as part of an ECU such as, for example, electronic control unit 250. In other embodiments, trajectory prediction circuit 310 can be implemented independently of the ECU.

Trajectory prediction circuit 310 in this example includes a communication circuit 301, a decision circuit 303 (including a processor 306 and memory 308 in this example) and a power supply 312. Components of trajectory prediction circuit 310 are illustrated as communicating with each other via a data bus, although other communication in interfaces can be included.

Processor 306 can include one or more GPUs, CPUs, microprocessors, or any other suitable processing system. Processor 306 may include a single core or multicore processors. Memory 308 may include one or more various forms of memory or data storage (e.g., flash, RAM, etc.) that may be used to store instructions and variables for processor 306 as well as any other suitable information, such as one or more of the following elements: position data; vehicle speed data; risk and mitigation data, along with other data as needed. Memory 308 can be made up of one or more modules of one or more different types of memory, and may be configured to store data and other information as well as operational instructions that may be used by processor 306 to trajectory prediction circuit 310.

Although the example of FIG. 3 is illustrated using processor and memory circuitry, as described below with reference to circuits disclosed herein, decision circuit 303 can be implemented utilizing any form of circuitry, including, for example, hardware, software, or a combination thereof. By way of further example, one or more processors, controllers, ASICs, PLAS, PALs, CPLDs, FPGAs, logical components, software routines, or other mechanisms might be implemented to make up a trajectory prediction circuit 310.

Communication circuit 301 includes either or both a wireless transceiver circuit 302 with an associated antenna 314 and a wired I/O interface 304 with an associated hardwired data port (not illustrated). Communication circuit 301 can provide for vehicle-to-everything (V2X) and/or vehicle-to-vehicle (V2V) communications capabilities, allowing trajectory prediction circuit 310 to communicate with edge devices, such as roadside unit/equipment (RSU/RSE), network cloud servers and cloud-based databases, and/or other vehicles via network 390. For example, V2X communication capabilities allow trajectory prediction circuit 310 to communicate with edge/cloud servers, roadside infrastructure (e.g., such as roadside equipment/roadside unit, which may be a vehicle-to-infrastructure (V2I)-enabled street light or cameras, for example), etc.

As this example illustrates, communications with trajectory prediction circuit 310 can include either or both wired and wireless communications circuits 301. Wireless transceiver circuit 302 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked, or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by trajectory prediction circuit 310 to/from other entities such as sensors 352 and vehicle systems 358.

Wired I/O interface 304 can include a transmitter and a receiver (not shown) for hardwired communications with other devices. For example, wired I/O interface 304 can provide a hardwired interface to other components, including sensors 352 and vehicle systems 358. Wired I/O interface 304 can communicate with other devices using Ethernet or any of a number of other wired communication protocols whether standardized, proprietary, open, point-to-point, networked, or otherwise.

Power supply 312 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 352 can include, for example, sensors 252 such as those described above with reference to the example of FIG. 2. Sensors 352 can include additional sensors that may or may not otherwise be included on a standard vehicle with which trajectory prediction system 300 is implemented. In the illustrated example, sensors 352 include vehicle acceleration sensors 318, vehicle speed sensors 320, wheelspin sensors 316 (e.g., one for each wheel), accelerometers such as a 3-axis accelerometer 322 to detect roll, pitch, and yaw of the vehicle, environmental sensors 328 (e.g., to detect salinity or other environmental conditions), and proximity sensor 330 (e.g., sonar, radar, lidar, or other vehicle proximity sensors). Additional sensors 332 can also be included as may be appropriate for a given implementation of trajectory prediction system 300.

System 300 may be equipped with one or more image sensors 360. These may include front facing image sensors 364, side facing image sensors 366, and/or rear facing image sensors 368. Image sensors may capture information which may be used in detecting not only vehicle conditions but also detecting environmental and proximity conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 360 can be used, for example, to detect objects in an environment surrounding a vehicle comprising trajectory prediction system 300, for example, surrounding vehicles, roadway environments, road lanes, road curvatures, obstacles, and so on. For example, a one or more image sensors 360 may capture images of agents of a scene in the surrounding environment. As another example, object detecting and recognition techniques may be used to detect agents, objects, and environmental conditions, such as, but not limited to, road conditions, surrounding agent behavior (e.g., driving behavior), and the like. Additionally, sensors may estimate proximity between the vehicle and nearby agents. For instance, image sensors 360 may include cameras that may be used with and/or integrated with other proximity sensors 330 such as LIDAR sensors or any other sensors capable of capturing a distance.

Vehicle systems 358, for example, systems and subsystems 258 described above with reference to the example of FIG. 2, can include any of a number of different vehicle components or subsystems used to control or monitor various aspects of the vehicle and its performance. In this example, vehicle systems 358 includes a vehicle positioning system 372; engine control circuits 376 to control the operation of engine (e.g. internal combustion engine 214 and/or motors 222); object detection system 378 to perform image processing such as object recognition and detection on images from image sensors 360, proximity estimation, for example, from image sensors 360 and/or proximity sensors, etc. for use in other vehicle systems; torque splitter(s) 374, steering system 284 (which may be the steering by-wire system described in conjunction with FIG. 2) to turn the wheels of vehicle 100, autonomous driving systems 380 for controlling a vehicle in the autonomous and/or semi-autonomous driving mode, and other vehicle systems 382 (e.g., Advanced Driver-Assistance Systems (ADAS), such as forward/rear collision detection and warning systems, pedestrian detection systems, and the like).

Autonomous driving systems 380 can be operatively connected to the various vehicle systems 358 and/or individual components thereof. For example, autonomous driving systems 380 can send and/or receive information from the various vehicle systems 358 to control the movement, speed, maneuvering, heading, direction, etc. of the vehicle. Autonomous driving systems 380 may control some or all of these vehicle systems 358 based on driver input or independent of driver input and, thus, may be semi-or fully autonomous.

Network 390 may be a conventional type of network, wired or wireless, and may have numerous different configurations, including a star configuration, token ring configuration, or other configurations. Furthermore, network 390 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, network 390 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication, and satellite communication. The network may also include a mobile data network that may include 3G, 4G, 5G, LTE, LTE-V2V, LTE-V2I, LTE-V2X, LTE-D2D, VOLTE, 5G-V2X, or any other mobile data network or combination of mobile data networks. Further, network 390 may include one or more IEEE 802.11 wireless networks.

In some embodiments, network 390 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications, or any combination thereof.

During operation, trajectory prediction circuit 310 can receive information from various vehicle sensors and commit the information to memory 308. Communication circuit 301 can be used to transmit and receive information between trajectory prediction circuit 310 and sensors 352, and trajectory prediction circuit 310 and vehicle systems 358. Also, sensors 352 may communicate with vehicle systems 358 directly or indirectly (e.g., via communication circuit 301 or otherwise).

In various embodiments, communication circuit 301 can be configured to transmit data and other information from sensors 352 and/or vehicle systems 358 for use in training a multi-agent trajectory prediction model. The data and other information may be historical trajectory data over a past time horizon. In some cases, map information may be also be provided along with the historical trajectory data. As described below, a multi-agent trajectory model may be trained on historical trajectory data and map information from a plurality of agents, including a vehicle having trajectory prediction circuit 310 installed therein, and communication circuit 301 can be used to receive the trained multi-agent trajectory model, which can be committed to memory 308. Trajectory prediction circuit 310 may then apply recent trajectory data (e.g., for a recent time horizon defined between a current time and prior time) for agents in a scene of an environment surrounding the vehicle having trajectory prediction circuit 310 installed therein—including recent trajectory data of the vehicle itself and map information of the environment—to predict future trajectories for each of the agents in the scene for a future time horizon. Based on the multi-agent trajectory predictions, trajectory prediction circuit 310 can determine autonomous driving commands for autonomous and/or semi-autonomous driving operation. Communication circuit 301 can receive the autonomous driving commands as control signals and communication circuit 301 can be used to send the autonomous driving commands as control signals or other control information to various vehicle systems 258 as part of executing the autonomous driving command. For example, communication circuit 301 can be used to send signals to, for example, one or more of: torque splitters 374 to control front/rear torque split and left/right torque split; ICE control circuit 376 to, for example, control motor torque, motor speed of the various motors in the system; and steering system 384 to, for example, increase lateral force. The decision regarding what action to take via these various vehicle systems 358 can be made based on the information detected by sensors 352.

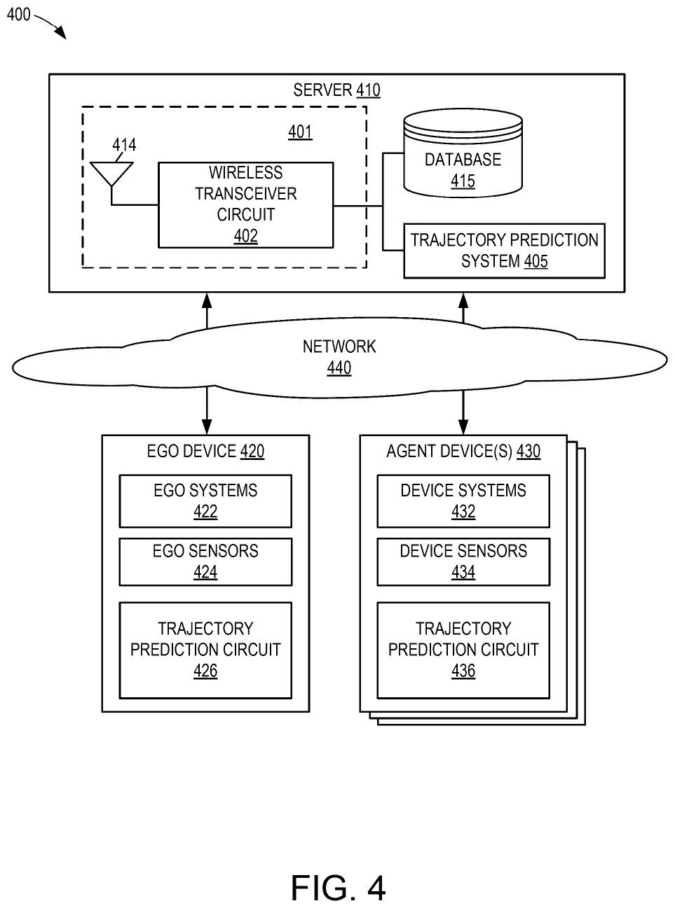

FIG. 4 is an example network architecture 400 of a multi-agent trajectory prediction system in accordance with various embodiments disclosed herein. Architecture 400 includes a server 410 comprising a trajectory prediction system 405, an ego device 420 (sometimes also referred to as a target device), and one or more agent devices 430. Server 410, ego device 420, and agent devices 430 can each communicate with one another in this example, directly or through network 440.

Server 410 may be an edge server, a cloud server, or a combination of the foregoing. For example, server 410 may be an edge server implemented as a processor-based computing device installed in roadside infrastructure (e.g., roadside unit (RSU) or roadside equipment (RSE), and/or some other processor-based infrastructure component of a roadway). As another example, a cloud server may be one or more cloud-based instances of a processor-based computing device resident on network 440. Server 410 in this example includes a communication circuit 401 and trajectory prediction system 405. Trajectory prediction system 405 comprises code and routines that, when executed by a processor, cause the processor to control various aspects of multi-agent trajectory prediction, as described below in greater detail. Server 410 may include, for example, a microcomputer that includes one or more processing units (e.g., microprocessors), memory storage (e.g., RAM, ROM, etc.), and I/O devices. Server 410 may store information and data related to multi-agent trajectory prediction in a cloud-based database 415, which may be resident on network 440. Database 415 may include one or more various forms of memory or data storage (e.g., flash, RAM, etc.) that may be used to store suitable information, such as one or more of the following elements: historical trajectory data for a plurality of agents (such as, but not limited to, ego device 420 and/or agent devices 430), observed trajectory data for a plurality of agents, and map information of geographic locations, along with other data as needed. Map information may be provided as polylines defining roadways, lanes, center lanes, and the like. The processing units of cloud server 410 execute instructions stored in memory to execute and control functions of the multi-agent trajectory prediction.

Communication circuit 401 includes either or both of a wireless transceiver circuit 402 with an associated antenna 414 and a wired I/O interface with an associated hardwired data port (not illustrated). Communication circuit 401 can provide for V2X communication capabilities, such that server 410 can communicate with connected devices, such as ego device 420 and agent devices 430 via network 440.

Ego device 420 may be any type of agent device, but for explanation purposes will be described in reference to an “ego vehicle.” Ego device 420 may be any type of vehicle, for example, vehicle 200 of FIG. 2. As such, ego device 420 can comprise systems 422 and sensors 424 that may be substantially similar to vehicle systems 358 and sensors 352 of FIG. 3. Ego device 420 may also include trajectory prediction circuit 426, which may be substantially similar to trajectory prediction circuit 310 of FIG. 2.

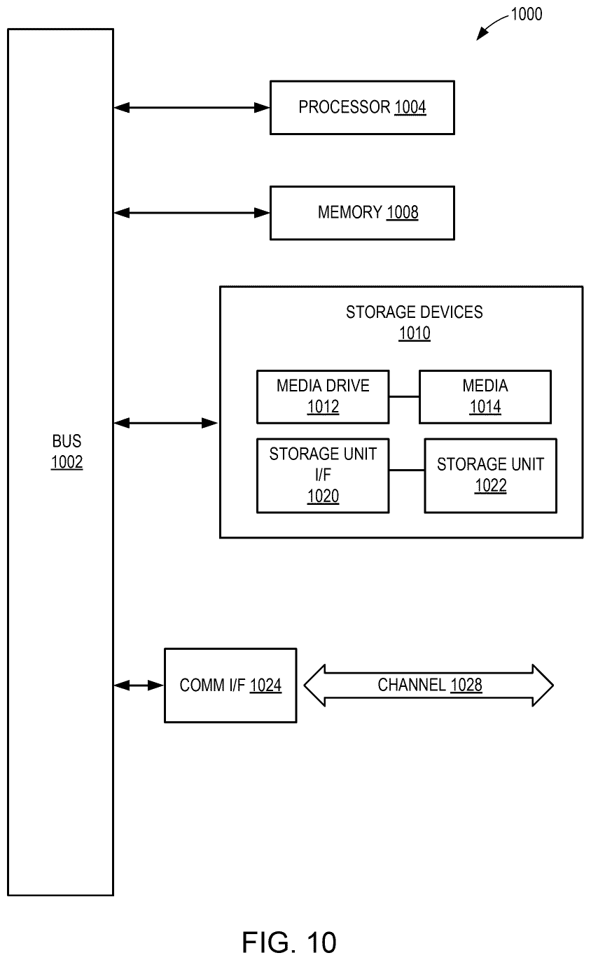

Each agent device 430 may be any type of agent device, such as, but not limited to, a vehicle, RSE/RSU, a smartphone, a desktop computer, a laptop computer, a tablet computer, a netbook computer, a personal digital assistant (PDA), a wearable smart device such as smartwatches and the like, a mobile phone, a smart phone, a smart terminal, a dumb terminal, and the like. In some embodiments, an agent device 430 may be an unmanned ariel vehicle (UAV), such as, but not limited to, a drone. Each agent device 430 may be implemented, for example, as a computing component, such as computing component 1000 of FIG. 10. Furthermore, each agent device 430 can comprise systems 432 and sensors 434 that may be substantially similar to vehicle systems 358 and sensors 352 of FIG. 3, dependent on the specific type of agent device implemented. Agent devices 430 may also include trajectory prediction circuit 436, which may be substantially similar to trajectory prediction circuit 310 of FIG. 2.

Network 440 may be a conventional type of network, wired or wireless, and may have numerous different configurations, including a star configuration, token ring configuration, or other configurations. For example, network 440 may be, for example, substantially similar to network 390 of FIG. 3.

Accordingly, for example, agent devices 430 and/or ego device 420 may transmit data and other information to server 410 via their respective communication circuits for use in training a multi-agent trajectory prediction model by trajectory prediction system 405, as described below. For example, agent devices 430 and/or ego device 420 may transmit historical trajectory data along with map information to server 410. Server 410 may commit the data to cloud-based database 415 for storage and apply the data to a machine learning algorithm as training data to train the multi-agent trajectory prediction model. Once trained, server 410 may transmit the trained multi-agent trajectory prediction model to one or more of ego device 420 and agent device 430 for use in predicting multi-agent trajectories and actions of respective agents. For example, ego device 420 may receive the trained multi-agent trajectory prediction model from server 410, commit the multi-agent trajectory prediction model to memory, and apply recent trajectory information for multiple agents within a scene surrounding ego device 420, along with map information, to the multi-agent trajectory prediction model. Using the multi-agent trajectory prediction model, ego device 420 may predict behaviors of each of the agents, which in various examples can be used to determine autonomous driving commands for execution by autonomous driving system.

The multi-agent trajectory prediction model, according to embodiments disclosed herein, leverages game-theoretic planning and joint trajectory prediction. For example, embodiments disclosed herein utilize dynamic games and inverse optimal control; multi-agent prediction; and diverse prediction as described below.

Dynamic games refers to a framework for analyzing a number of N-agent driving scenarios. Optimal control policies can satisfy Local Nash Equilibrium (LNE), where each agent's expected payoff is locally optimal with respect to their control strategy. Augmented Lagrangian methods are example methods for solving for LNE-satisfying control strategies with fast convergence times. An equilibrium strategy can be extended to stochastic control policies under a maximum entropy (MaxEnt) framework. Further, prediction models can be leveraged in a model-predictive control planner to iteratively solve for an agent's optimal responses.

Other frameworks provide for socially aware agents, where agents' actions are determined according to what is optimal for the group of agents, and bounded rationality, where the optimal response is stochastic. Additionally, frameworks are possible that provide guarantees on the optimally of predictions covering multiple modes of agent interaction.

Another example framework involves modeling uncertainty in a cost function, state, or latent mode. Cost function parameters may be estimated using an Extended Kalman Filter. Belief space planning combined with general dynamic games may result in an efficient computation framework for linear feedback policies. Equilibrium solving may be extended to multiple modes, permitting agents to consider multiple equilibria simultaneously by conditioning on discrete latent modes. In another framework, parameters of a quadratic potential game can be learned, and then the optimal policies of each agent solved online to predict the outcome of a highway merge scenario between two agents.

Embodiments disclosed herein provide various advantages over the above outlined frameworks. For example, the embodiments disclosed herein do not rely on assuming specific knowledge about the game payoff structure, beyond the maximum-entropy framework. Furthermore, some embodiments leverage inverse reinforcement learning (IRL) to learn agent policies offline, allowing better scaling to real-time evaluation. Additionally, embodiments disclosed herein can be evaluated on multi-agent scenarios of varying complexity (e.g., a number of agents greater than two, such as three, four, or more agents), while the conventional frameworks may have been limited to two-agent scenarios. Further, inverse optimal control and reward learning may be used by the disclosed embodiments, even at a single agent level, for understanding human decision-making, facilitating analysis of bounded rational decision-making under a maximum entropy (MaxEnt), and reflecting the reality that road agents are not always greedy.

Multi-agent prediction, within the field of trajectory prediction, may involve agent-to-agent interactions that may be a critical consideration when scaling to a multi-agent setting. Modern joint predictors in the prediction model make use of attention-based architectures for fusing multi-modal scene, map, agent, and interaction information. The output of a joint predictor may be a raw trajectory sample, a weighted set, or a mixture model over discrete modes. Some frameworks explicitly model discrete agent interactions in order to better account for them and improve accuracy. A game-theoretic prediction may leverage an Markov Decision Process (MDP) policy model and fictitious play for posterior distribution for (unimodal) pedestrian prediction. Embodiments disclosed herein, however, may emphasize multi-modality and offline rollouts to replace fictitious play in the prediction framework.

For diverse predictions in sample-based predictions, diversity of samples may be maintained to represent numerous distinct outcomes. Metric learning, for example, can provide a mechanism for encouraging diversity using Farthest Point Sampling (FPS), Non-Maximum Suppression (NMS), and/or neural adaptive sampling. Diversity in the sampling may be aided by specific underlying representation, such as a latent layer, a mixture model, a set of anchor points, or the use of a bagging algorithm on the trajectories. Further, knowledge of downstream tasks may allow adaptation of the prediction samples so as to improve results. Embodiment disclosed herein provide for a prediction framework that can achieve improved prediction coverage of semantic interactions without a need for explicit taxonomies or task definition for semantic coverage by leveraging learned game-theoretic utilities.

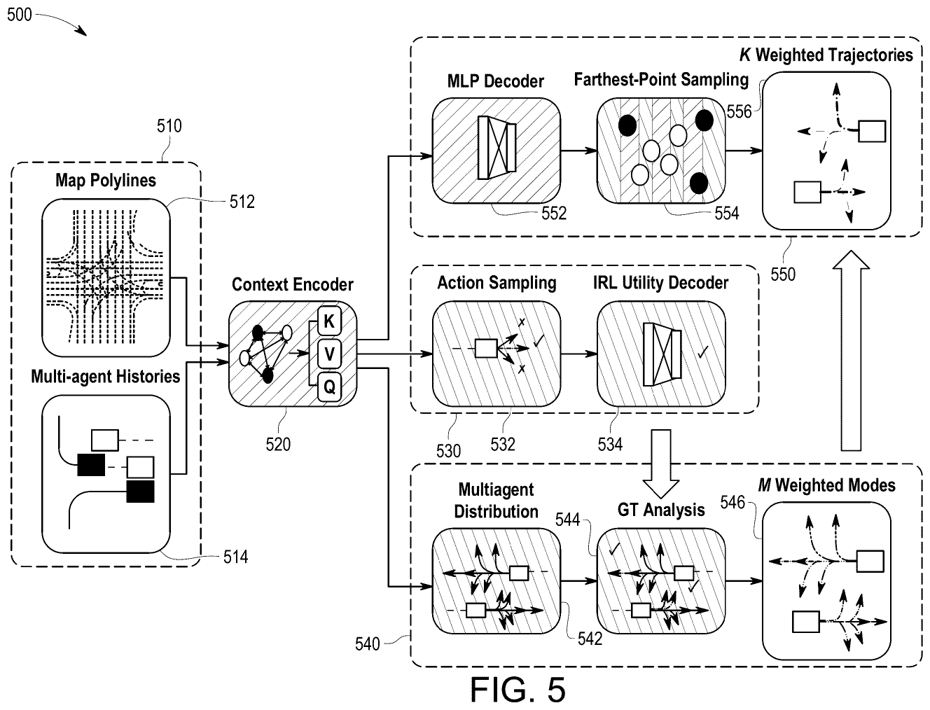

FIG. 5 is a schematic block diagram of an example architecture 500 for trajectory prediction according to embodiments disclosed herein. FIG. 5 illustrates a plurality of modules that may be executed to by, for example, server 410, ego device 420, and/or agent devices 430 of FIG. 4 for training a multi-agent trajectory prediction model on historical training data, as well as applying testing or runtime data to the trained multi-agent trajectory prediction model for predicting agent behaviors for a future horizon.

As used herein “modules” may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Modules may be stored in memory as instructions that are executable by a processor to causes the systems disclosed herein to perform functionality as described herein.

The modules may be grouped into multiple phase of data collection, training, and testing/runtime (referred to herein as a prediction phase). For example, a data collection phase 510 is provided where data is collected from data sources. The collected date may be training data and/or testing/runtime data depending on the phase performed. In a training phase, training data in the form of historical trajectories and map information for a past time horizon can be applied to machine learning reward algorithm in reward model training branch 530 that is configured to learn a reward model (e.g., a utility model) for each agent. The data collection phase 510 may be executed online (e.g., in real-time) or offline (e.g., in advance of the prediction).

A game-theoretic training branch 540 receives the learned utility model from reward model training branch 530 and applies training data along with the utility model to a game-theoretic mode-finding algorithm to learn, for different scenarios, various modes of distinct outcomes by learning mode-finding models for each agent. For example, game-theoretic training branch 540 ingests sample trajectories for each agent and perturbs them via a mode-finding algorithm to output a number M of most likely modes (e.g., M weighted modes) on an agent-basis, which is provided to a prediction phase 550 in the form of a prediction coverage loss. Game-theoretic training branch 540 may be executed offline.

During prediction phase 550, a predictor can be initially trained on the coverage loss term from game-theoretic training branch 540 and ingests testing/runtime data in the form of recent trajectories of agents and map information of a recent time horizon. A predictor can refer to one or more modules utilized during data collection phase 510, context encoder module 520, and prediction phase 550. That is, for example, a predicator can refer to map module 512, trajectory module 514, context encoder module 520, decoder module 552, sampling module 554, and prediction phase 550 collectively, or a combination of one or more of the foregoing modules. Prediction phase 550 can be used to predict future trajectories of multiple agents, which an ego agent can then use to determine an optimal trajectory of its own that navigates a scenario in view of the predicted trajectories of nearby agents. At a high level, decoder module 552 can be executed to output a large set of all possible trajectories for agents. Sampling module 554 then picks trajectories that are mutually far apart representing distinct modes. K weighted trajectory module 556 then weights the selected modes and outputs these weighted modes, which are a subset of all the possible trajectories from the decoder module 552.

Said another way, architecture 500 executes prediction phase 550 using M weighted modes obtained by game-theoretic training branch 540, using reward are determined in reward model training branch 530. Additionally, prediction phase 550 can provide a supervisory reward for training the predictor. In operation, each of reward model training branch 530, game-theoretic training branch 540, and prediction phase 550 can be run in parallel; however, game-theoretic training branch 540 provides a game-theoretic analysis component that is not available in prediction phase 550 alone. Thus, the output of prediction phase 550 provides semantically distinct modes that can be used to supervise predictions in prediction phase 550.

As an illustrative example, game-theoretic training branch 540 may determine weights on a mode basis, such as a pedestrian is 5% likely to cross a road (e.g., a first mode) and 95% likely not to cross (e.g., a second mode). Using this information, prediction phase 550 may afford two trajectories and, based on the M weight modes, assign a weight of 5% to a trajectory that is crossing and 95% of trajectory that is not crossing. This distribution provides increased coverage as compared to, for example, assigning weights to two trajectories of not crossing where an agent decided to drive through the intersection and the reward for the pedestrian would be pretty bad.

In more detail, the training phase (e.g., reward model training branch 530 and game-theoretic training branch 540) takes as input data from agents (e.g., ego device 420 and/or one or more agent devices 430) observed agent trajectories {Xₜ}_{t=-T}_{ₚ}⁻¹ and map information about the scene over a past time horizon Tₚ. As shown in FIG. 5, map module 512 and trajectory module 514 may be implemented to collect the input data, such as from sensors 352 and vehicle systems 358 in the case of a vehicle implemented as an agent device. The output from runtime phase 550, from K weighted trajectory module 556, is a set of weighted trajectories {(ω^{k}, τ^{k})}ₖ₌₁^{K}, where τ^{k}={xₜ}ₜ₌₁^{T} is a series of multiagent states xₜ with time horizon T. As shown in FIG. 5, the solid line shown in K weighted trajectory module 556 represents the highest weighted trajectory for each agent i. Prediction can be evaluated according to spatial accuracy measures, as well as by coverage of distinct outcomes.

A IRL utility network of reward model training branch 530 uses outputs emitted from context encoder module 520, which may be identical to the encoder of the prediction module. For example, sampling module 532 takes as input from context encoder module 520 weighted trajectories, the weighted predictions, and the current acceleration uₜⁱ, for each agent i at time t. Actions sampled by sampling module 532 are passed through an attention encoder and through an decoder 534 to obtain a scalar reward model.

In an embodiment, reward model training branch 530 learns an agent-level optimal-response model that evaluates the utility of an action uₜⁱ conditioned on the joint state xₜ. For example, sampling module 532 samples a historical trajectory actually taken by each agent (illustratively shown in sampling module 532 as a checked line) and samples (e.g., computes) action variations (or distributions) around the actual trajectory (e.g., shown as “X” actions) for that agent. Decoder 534 then assigns rewards to the actual and computed actions to encourage the path actually taken to learn the utility reward model for each agent. That is, for example, a reward assigned to an actual path taken is larger than that of a variation, and variations more similar to the actual path are provided rewards that are larger than those more dissimilar. In this way, the rewards can be used to train the reward model to encourage actual paths taken over variations.

In an example implementation, sampling module 532 computes log-likelihood actions for each agent, based on a maximum entropy objective:

$${J}^{i} ( {π}^{i} ) = {𝔼}^{π} [ {\sum }_{t = 1}^{T} r ( {x}_{t} , {α}_{t} ) + H [ {π}^{i} ( \cdot \vert {x}_{t} ) ] ] \qquad Eq . 1$$

where Σₜ₌₁^{T}r(xₜ, αₜ) represents a cumulative reward attained by agent i over the joint trajectory τ and H[πⁱ(·|xₜ)] represents a policy Shannon entropy. Decoder 534 then learns the policy πⁱ for each agent i that maximizes the objective in Eq. 1, and assumes agents follow Local Nash Equilibrium (LNE).

LNEs can be used in autonomous driving systems for modeling interactions in merging, highway over-taking, and racing. The LNE policies can satisfy a coupled Boltzmann distribution:

$${π}^{i} ( {u}_{t}^{i} \vert {x}_{t} ) = exp ( {A}^{i} ( {x}_{t} , {u}_{t}^{i} ) ) ∀ {π}^{i} \qquad Eq . 2$$

where Aⁱ represents an advantage function:

$${A}^{i} ( x , u ) = {\overline{Q}}^{i} ( {x}_{t} , {u}_{t}^{i} ) - {V}^{i} ( {x}_{t} ) \qquad Eq . 3$$

where Q̅ⁱ(xₜ, uₜⁱ) is defined as an expectation over the policies of all other agents ¬i, as provided here:

$${\overline{Q}}^{i} ( {x}_{t} , {u}_{t}^{i} ) := {E}^{{π}^{¬ i}} [ {\overline{Q}}^{i} ( {x}_{t} , {u}_{t} ) ] \qquad Eq . 4$$

where uₜ represents the joint action available at time t. Eq. 4 reflects agent i's optimal response to expected actions of all other agents ¬i. As a consequence, agent i's policy given in Eqs. 2 and 4 is a function only of the payoffs of the actions of agent i. In a maximum entropy dynamic game framework according to the embodiments disclosed herein, the value function can be defined as:

$${V}^{i} ( {x}_{t} ) := log \int exp {\overline{Q}}^{i} ( {x}_{t} , u ) du \qquad Eq . 5$$

which serves as the log-partition function in the MaxEnt setting. Each agent's policy satisfies the Markov property and is estimated using the Laplace approximation or importance sampling. Below, IRL is applied to learn the optimal-response policy in Eq. 4.

During inverse reinforcement learning at decoder 534, in this example, it may be assumed that road agents have double-integrator dynamics, (e.g., uₜ=\ddot{x}ₜ, actions are accelerations, with other options also possible). Given a dataset [symbol] of state-action histories of each agent (e.g., trajectories), decoder 534 regresses a log-likelihood of a single agent's action, conditioned on the multi-agent history, as given by Eq. 2. Decoder 534 assumes all agents in the data follow LNE and compute the optimal response in Eq. 4 so as to avoid the inner expectation in Eq. 2. The item-wise loss is minimized as follows:

$${ℒ}^{i} ( u ) = - log {π}^{i} ( u ) = {V}^{i} ( x ) {\overline{Q}}^{i} ( x , u ) \qquad Eq . 6$$

Using the item loss of [symbol] ⁱ(u), decoder 534 seeks to learn the multi-agent MaxEnt policy that maximizes the likelihood of the data:

$${ℒ}_{IRL}^{i} ( 𝒟 ) = {𝔼}_{𝒯 \sim D} [ {ℒ}^{i} ( 𝒯 ) ] \qquad Eq . 7$$

Decoder 534 then optimizes for the maximum likelihood, addressing the partition function during training. The value function is trained by minimizing the mean squared error with the log partition function.

The predictors provided by architecture 500 leverages an encoder-decoder model, as shown in FIG. 5. Map information, provided in the form of map polylines defining a roadway and lanes for past time horizon T_{P}, may be received, along with multi-agent trajectories (e.g., {Xₜ}_{t=-T}_{ₚ}⁻¹) about the scene over past time horizon Tₚ. For each agent i, context encoder module 520 can use a Long Short-Term Memory (LSTM) network to encode the position encoding from time step −Tₚ+1 to T₀ into a hidden state h_{Si}. The hidden states of each agent can be concatenated into a joint hidden state h_{S} using multi-head attention. The k weighted trajectory module 556 outputs the K sample trajectories and their weights, which are candidate lists output by decoder module 552 and pruned in sampling module 554. The trajectory predictions are given as set S.

Embodiments disclosed herein provide a novel approach for generating diverse interaction prediction rollouts using maximum entropy policies, as described above. Weighted and subsampled trajectories from the multiagent distribution module 542 and associated game-theoretic scores from decoder 534 can be passed as input to the GT analysis module 544. The output from multi agent distribution module 542 can be an augmented version of the final output from k weighted trajectory module 556, and in some cases the output from multiagent distribution module 542 can be equivalent to the output from decoder module 552, but with more samples. After applying a mode-finding algorithm at decoder 534, game-theoretic modes can be leveraged in the predictor training as a coverage loss that is supplied to prediction phase 550.

Some embodiments of GT analysis module 544 disclosed herein enumerate multiple modes within the multi-agent trajectories using a local optimization algorithm. Embodiments disclosed herein are implemented using a Mean Shift algorithm as an example local optimization algorithm; however any local optimization algorithm can be implemented as desired for a given application. For example, the Mean Shift algorithm can be used explore the game-theoretic modes of the posterior distribution over trajectories, in terms of their sum of utility along the trajectory.

Given a set S of multi-agent trajectory predictions emitted from the predictor, sampling module 554 evaluates the mutual distances of multi-agent trajectories, and iteratively seeks for distinct modes based on the M weighted modes emitted by M weighted mode module 546. The sampling module 554 in the example of FIG. 5 executes a farthest-point sampling (FPS) algorithm to find distinct trajectories by maximizing the mutual distances between them trajectories. Other samples techniques may be used as known in the art. Sampling module 554 may be blind to game-theoretic rewards, which are explored using the GT analysis module 544. As sampling module 554 can executed in real time and thus is executed as part of the predictor, while game-theoretic training branch 540 may not be performed in real time and, instead, executed offline. As such, mode analysis performed by game-theoretic training branch 540 serves to improve outputs of the decoder 552, so sampling module 554 can function more effectively.

As shown in the illustrative example of FIG. 5, M weighted mode module 546 includes six alternative trajectories grouped into three semantically distinct modes illustrated using different line types to show each mode. To explore candidate trajectories, GT analysis module 544 creates a perturbation set [symbol] by rescaling the velocity with scale sampled from U∈{0.3, 0.7, 1.0}. GT analysis module 544 then perturbs each trajectory's polynomial representation by adding Gaussian noise with small variance σ to the polynomial coefficients. Given samples K=| [symbol] | samples, GT analysis module 544 seeks to estimate the modes of the joint trajectory distribution according to Boltzmann (e.g., bounded rational) policies as provided by decoder 534. By iteratively evaluating Eq. 2, a log-likelihood of a joint trajectory (e.g., log-likelihood of modes) is given as follows under deterministic dynamics:

$$log p ( τ ) = {Σ}_{t = 1}^{T} {Σ}_{i = 1}^{N} log {π}^{i} ( {x}_{t}^{i} \vert {x}_{t - 1} ) \qquad Eq . 8$$

The product distribution of Eq. 8 is another Boltzmann distribution with partition function equal to one. Hence, the modes of p(τ) should maximize the cumulative advantage (e.g., the sum of the utilities of each agent along a joint trajectory) as follows:

$${S}_{( τ )} := {Σ}_{i = 1}^{M} {Σ}_{t = 1}^{T} {A}^{i} ( {x}_{t} , {u}_{t} ) \qquad Eq . 9$$

GT analysis module 544 then uses a scaled Gaussian as the Mean Shift kernel (Eq. 10) as target density:

$$p ( τ ) = exp ( S ( τ ) ) \qquad Eq . 10$$

GT analysis module 544 uses the drawn perturbation set, along with its sampling probabilities to perform the Mean Shift iterations similar to importance sampling. Each mode can be modeled as a Gaussian, the number of modes M, and their mean and variance.

During testing/runtime phases, context encoder module 520 takes as input the observed agent trajectories {oₜ}_{t=-T}⁻¹and map information about a scene over a recent time horizon Tₚ. The past time horizon Tₚ may be a time horizon defined between a current/present time and a prior time preceding and leading up to the current or recent time T. The observed trajectories can be passed through an attention-based LSTM at context encoder module 520. Temporal edges can be represented via edge modules, and nodes and self-edges represented via an LSTM. Context encoder module 520 encodes node and edge features via a Multilayer Perception (MLP) model over normalized coordinates. The map information can be encoded via an attention model, which takes the map input as polylines representing a set of lane centerlines, and performs self-attention to pool the encoded states from all centerlines.

Decoder module 552 can use a three-layer MLP decoder, in some examples, to compute joint predictions and the sample weight associated with each prediction. While LSTM and transformer architectures may offer better final displacement error (FDE) and/or average displacement error (ADE), an MLP decoder is used in various implementations due to its fast convergence and efficient integration into a game-theoretic trajectory evaluation framework. However, an FDE/ADE decoder may be implemented instead of an MLP decoder. In line with other trajectory prediction literature, decoder module 552 can emit K=6 samples.

Architecture 500 trains the prediction model by jointly optimizing prediction accuracy and mode prediction coverage. Prediction loss can be obtained as follows. Both Minimum over N (MoN) loss and classification loss can be included in the loss coverage term. MoN loss ( [symbol] _{acc}) and classification ( [symbol] _{class}) can be obtained by k weighted trajectory module 556 and provided as:

$${ℒ}_{a c c} = {‖ {τ}^{( k )} - \hat{τ} ‖}_{2} \qquad Eq . 11$$

$${ℒ}_{class} = - {\sum }_{k = 1}^{K} \{ k = \hat{k} \} log {ω}_{k} \qquad Eq . 12$$

where \hat{π} is the ground truth trajectory, and the index \hat{k} is given as the closest trajectory to the ground truth as measured by the L2 distance (e.g., an Euclidian distance). [symbol] {·} is an indicator function.

The coverage loss [symbol] _{cov} can be given as the Kullback-Leibler divergence (KL-divergence) between discrete mode distributions. GT analysis module 544 approximates a discrete distribution q over the mode support [1, . . . , M], given as:

$${q}_{m} ( ) = \frac{{g}_{m} ( )}{{Σ}_{{m}^{′} = 1}^{M} {g}_{{m}^{′}} ( )} \qquad Eq . 13$$

where gₘ( [symbol] ) := [symbol] (πₖ; μₘ, Σₘ), sums the contribution of each sample to the empirical mode likelihood, and (μₘ, Σₘ) parameterize the (locally) Gaussian likelihood of each mode m distributed according to the Mean Shift output. The predicted mode distribution in Eq. 13 is contrasted with the mode distribution according to the game-theoretic model, which is approximated discretely as:

$${q}_{m}^{*} ( ; ρ ) = \frac{exp ( ρ ( {τ}_{m}^{*} ) )}{{Σ}_{{m}^{′} = 1}^{M} exp ( ρ ( {τ}_{{m}^{′}}^{*} ) )} \qquad Eq . 14$$

where ρ→0 results in a uniform distribution for q* over the top M game-theoretic modes. The predictor's coverage loss can be obtained by m weighted mode module 546 and defined as the KL-divergence between q and q*, such as:

$${ℒ}_{c o v} = {D}_{K L} [ q ‖ {q}^{*} ] \qquad Eq . 15$$

In an illustrative example, ρ may be equal to 0.1. However, other values for ρ may be possible.

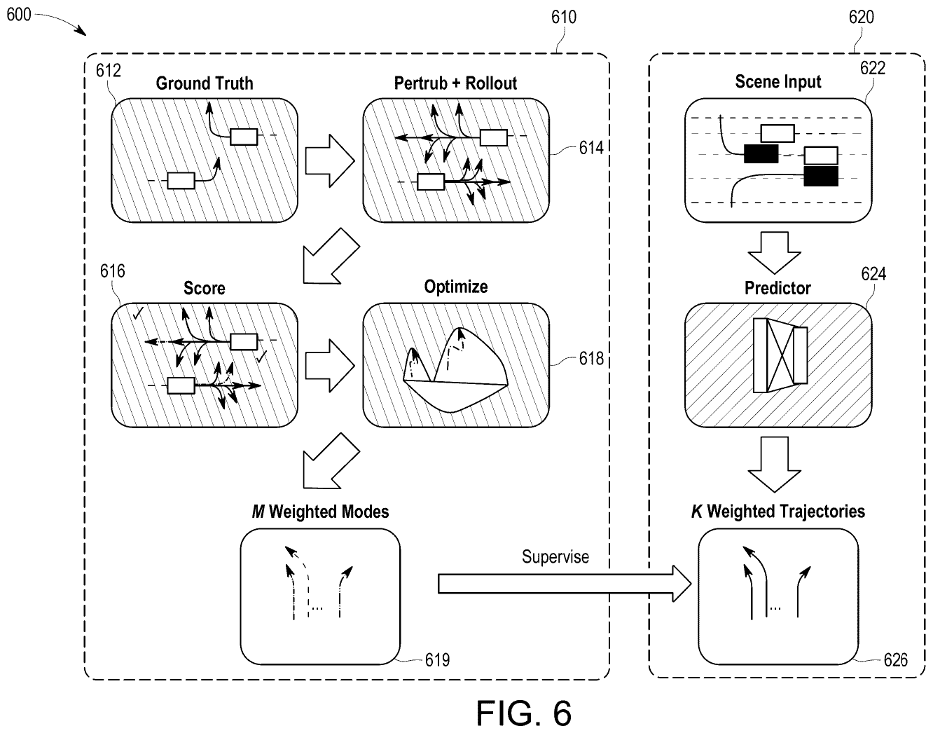

FIG. 6 illustrates an example mode optimization operation 600 according to embodiments disclosed herein. Mode optimization operation 600 can be performed by architecture 500 described above. For example, mode optimization operation 600 comprises Train time 610 and run time 620. Train time 610 may be an example of game-theoretic training branch 540 and run time 620 may be an example of prediction phase 550.

During a train time 610, ground truth module 612 obtains ground truth trajectories (e.g., actual trajectories traveled by the agents) and prediction rollouts are determined by perturbing joint ground truth trajectories at perturb and rollout module 614. The prediction rollouts result in trajectory variations (or distributions) for each ground truth to provide joint trajectory variation scenarios. A game-theoretic IRL model (e.g., game-theoretic IRL model 544) scores the prediction rollouts at score module 616, and the scored rollouts are given as input to an optimization module 618 for application to a optimization algorithm to find the optimal game-theoretic modes, for example, as described above in connection with FIG. 5. The optimal game-theoretic modes are provided as M weighed modes from weighted mode module 619. The results of the optimization are used to supervise a prediction at run time 620 as an auxiliary loss term, provided below in Eq. 16.

In more detail, at perturb and rollout module 614 rollouts are performed during train time 610 to explore different instantiations of multi-agent trajectories. Perturb and rollout module 614 takes as input the ground truth joint trajectories from ground truth module 612 and outputs several candidate plans with varied spatiotemporal characteristics for each agent.

Each agent's trajectory is perturbed randomly by perturb and rollout module 614 by scaling the velocity in the range, for example, {0.2, 0.8, 1.0, 1.25}. Additionally, polynomial noise may be added to the ground truth trajectory of each agent. After each agent's ground truth trajectory is perturbed, perturb and rollout module 614 combines the agent trajectories into a joint trajectory proposal. Each rollout state is iteratively evaluated, thereby simulating real-time decision-making, querying the game-theoretic advantage function for each agent at each time point.

Score module 616 evaluates the proposal trajectory as a whole using Eq. 9, and the log-likelihood of each proposal trajectory is determined. Next, optimization module 618 finds (e.g., identifies) local maximum (or optima) of trajectories using Mean Shift, as discussed above in connection with FIG. 5. After evaluating Eq. 9, weighted mode module 619 takes the top M most likely Mean Shift outputs as the game-theoretic modes, which is output as M weighted modes for use in supervising trajectory predictions made during run time 620.

In trajectory prediction phase, run time 620 samples a number of trajectories for a number of agents at input module 622, for example, K=6. Input module 622 may be an example of map module 512 and trajectory module 514. While K=6 is used herein, embodiments disclosed herein are not limited to 6; other numbers are applicable, such as less than or greater than 6. The sampled trajectories may be obtained by sampling agent data, such as an ego agent, and obtained from vehicle systems 358 and/or 352. To increase the intrinsic diversity of samples, a farthest point sampling (FPS) algorithm may be used, which takes as input a set of samples and iteratively constructs a set of representative samples for the set. In an example implementation, 60 predictor samples were obtained and subselect K=6 samples using FPS. An additional approach for diversifying samples can be via an L2 loss term, matching samples to the nearest neighbor from a set of FPS samples from the predictor. This loss may be denoted as FPS Loss.

Predictor models are trained at predictor module 624, which may be an example of decoder module 552 of FIG. 5. For example, an accuracy loss according to Eq. 11, a classification loss according to Eq. 12, and coverage loss according to Eq. 15 can be aggregated into a joint loss as follows:

$$ℒ = {ℒ}_{a c c} + {λ}_{1} {ℒ}_{class} + {λ}_{2} {ℒ}_{c o v} \qquad Eq . 16$$

Where each [symbol] is a fixed coefficient. The fixed coefficient may be varied for tradeoff between accuracy and mode coverage. Training can be performed in three stages: (i) baseline model training using FPS to ensure intrinsic coverage; (ii) game-theoretic IRL to regress trajectory log-likelihoods under the MaxEnt framework; and (iii) mode identification using Mean Shift with additional coverage loss.

Next, experimental results will be discussed demonstrating effectiveness of embodiments disclosed herein compared to baseline comparator.

In the experiments, architecture 500 is implemented using an encoder that embeds, via an LSTM, both the prediction target and context agent features in agent-normalized coordinates. The map embedding is obtained via an MLP. Cross attention was used to integrate map, target agent, and context agent features with a structure similar to VectorNet. The initial hidden dimension of each embedding was 128, and the final embedding had 768 dimensions. During sampling, 60 samples were obtained from the MLP decoder and reduced to K=6 samples using FPS. The weights were adjusted using the Voronoi weights returned from FPS. The IRL module included a pre-encoder identical to the prediction module, and action encoder via an additional LSTM with a dimension of 64, a multi-head attention layer, and a two-layer MLP with an output dimension of 2 for emitting the Q-value and V-value.

The coverage of semantic interactions can be evaluated by the entropy of the interactions labels p in the test set:

$$S C = - {\sum }_{m = 1}^{M} {p}_{m} log {p}_{m} \qquad Eq . 17$$

where pₘ:=z⁻¹Σₖ₌₁^{K} [symbol] [πₖ∈Sₘ]wₖ, z is a normalizing constant, and Sₘ is the set of trajectories that satisfy a semantic mode m, such as yielding. In experiments the dataset-averaged SC can be reported to gauge coverage.

Example implementations were evaluated on the Waymo Interactive Dataset, which has a diverse set of inter-agent driving interaction. The diversity of interaction, and long prediction horizon, can make it especially challenging for prediction. Joint trajectories for N=4 agents were predicted and resample trajectories at 5 Hz. As metrics, scene-averaged MoN average and final displacement errors (minSADE, minSFDE) were computed for each agent. The example implementations were tested in two stages. First, a backbone model for joint trajectory prediction was trained using only the accuracy loss (e.g., Eq. 11) and classification loss (e.g., Eq. 12). In parallel, the game-theoretic utility model was trained using Eq. 7. Once both models are converged, the coverage loss is computed using Eq. 15.

Table 1 below details the performance of example implementations on the Waymo Interactive Dataset against an LSTM and a GNN baseline (e.g., comparative examples 1 and 2, respectively). Several ablations of the embodiments disclosed here in were evaluated as Examples 1-4, including a backbone model (end of first stage of training). Additionally, the effect of FPS on semantic complexity is explored, including an FPS-promoting loss. Adding an additional FPS procedure after the second stage of training may be ineffective. While other goal-conditioned and transformer predictors may improve accuracy, instead improvements are focused to semantic coverage and comparison to other LSTM methods. However, the embodiments disclosed herein are compatible with many prediction pipelines. The coverage semantic complexity is shown in Eq. 17, and the KL divergence is shown in Eq. 15.

Table 1 below shows comparisons between comparative game-theory-agnostic models and example game-theory models according to embodiments disclosed here. As shown by the results in Table 1, embodiments disclosed herein improve coverage of modes, in parallel to achieving good accuracy in the predictions.

TABLE 1

| | | Accuracy | | Semantic | | |
|---|---|---|---|---|---|---|
| | Model | minSADE ↓ | minSFDE ↓ | KL-Div ↓ | SC(yield) ↑ | SC(follow) ↑ |
| Comparative Ex. 1 | Waymo LSTM Baseline | 2.42 | 6.07 | — | — | — |
| Comparative Ex. 2 | HeatIRm4 | 2.93 | 7.20 | — | — | — |
| Example 1 | GAME-UP (Backbone) | 2.34 | 5.57 | 0.113 | 0.0715 | 0.271 |
| Example 2 | GAME-UP (FPS) | 2.53 | 6.12 | 0.012 | 0.1346 | 0.521 |
| Example 3 | GAME-UP (FPA + FPS Loss) | 2.51 | 6.07 | 0.034 | 0.1265 | 0.422 |
| Example 4 | GAME-UP (GT Loss) | 2.34 | 5.56 | 0.058 | 0.213 | 0.5274 |

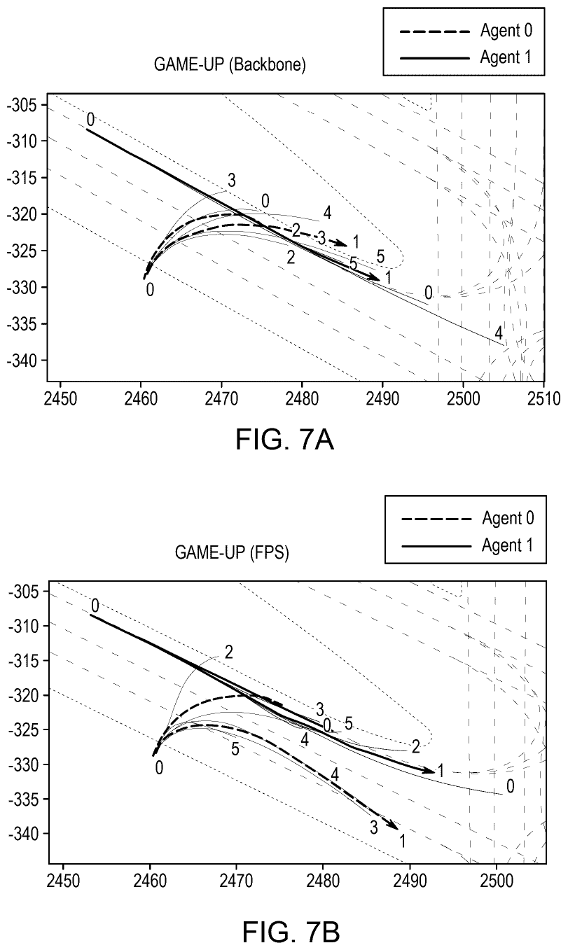

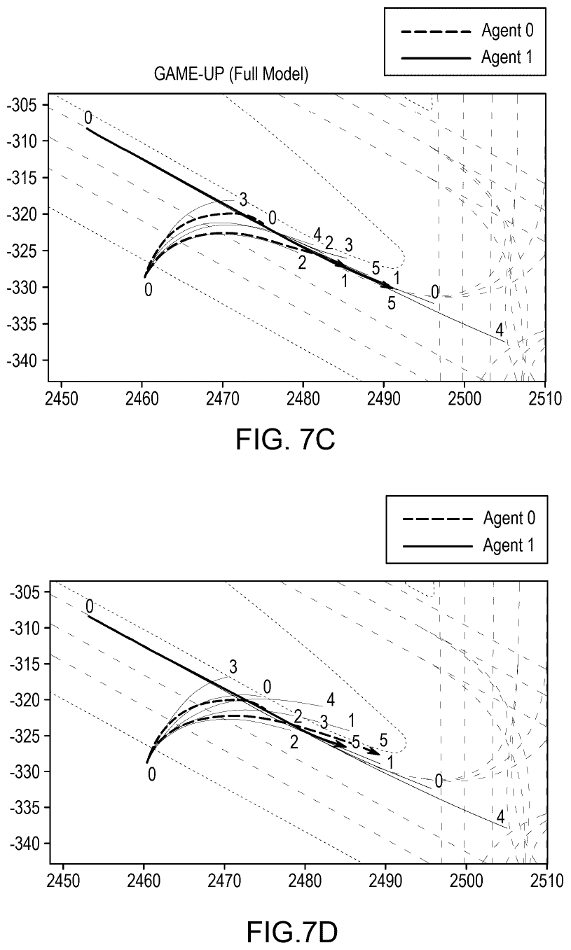

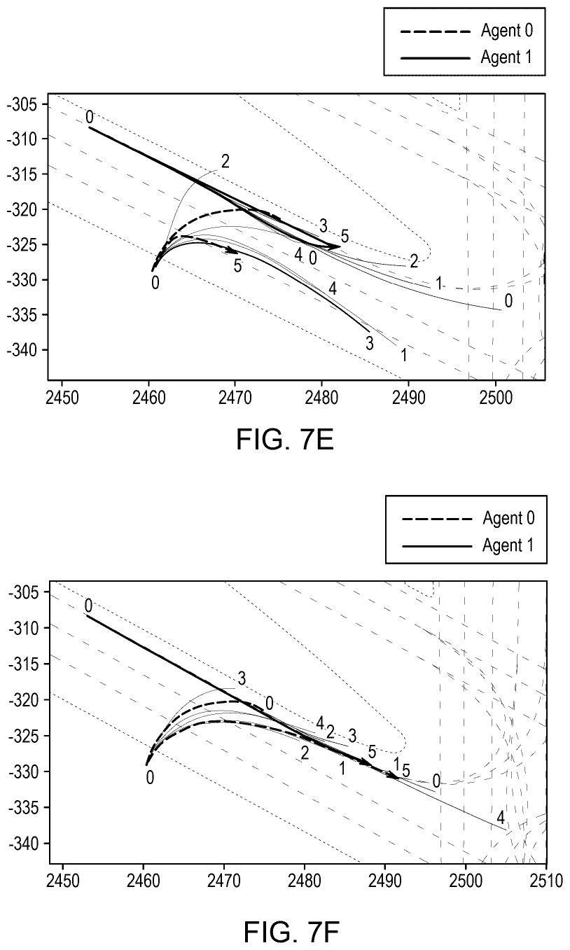

FIGS. 7A-7F illustrate example trajectories predicted by example implementations of the embodiments disclosed herein. More particularly, FIGS. 7A-7F show a scenario with high semantic entropy, with the example implementations capturing multiple modes of interaction that both FPS and the backbone model fail to capture accurately. Each plot of FIGS. 7A-7F depicts a bird's eye view of trajectories, in which the solid line represents predicted trajectories for a first agent and the dotted line represents predicted trajectories for a second agent. Each of the upper and lower rows depicts a different sample joint trajectory, highlighted for clarity (e.g., upper row represents a first agent represented by the solid line goes first and lower row represents a second agent represented by the dotted line goes first). In the leftmost column, where (a) and (b) correspond to Comparative Ex. 2 in Table 1, the sample 1 is unrealistic because it is off the map. In the middle column, where (b) and (e) correspond to Ex. 1 from Table 1, FPS offers metrically diverse samples but neglects agent interaction. In the right most column, where (c) and (f) correspond to Ex. 4 from Table 1 (e.g., a full mode), both semantic modes (e.g., agent represented by the solid line goes first in (c), as well as agent represent by the dotted line goes first in (f)).

Next, the efficacy of the example implementations can be demonstrated on three game-theoretic yield splits from the dataset: filtering for complex network interactions; qualitative results; and quantitative results.

Filtering for complex network interactions can be shown by evaluating coverage of game-theoretic outcomes. To evaluate coverage of game-theoretic outcomes, filters for two semantic interactions were applied, yield and follow at test time. Specifically, consider two agents i and j as nodes in a directed graph G to satisfy yield (i, j) interaction if (i) their traces are initially disjoint; (ii) their traces intersect; and (iii) their traces are finally disjoint, with agent i leading agent j. Follow was identical up to step (iii). Consider network yield interactions in which two agents (i, j) form a directed edge if and only if i yields to j. Which of the possible four-agent interactions are covered is evaluated by the sample set S, and compute the SC for these. Only network interactions are considered where the network is fully connected. In the following, splits with 1≤Y≤3 yield interactions are studied and compared to the full interaction dataset, FD. Each degree of complexity leads to approximately an order of magnitude of fewer examples: 1, 2, 3 yields 26, 961, 2456, and 77 examples were obtained, respectively.

For qualitative results, experimental results show that Examples 1-4 achieve higher coverage of scenario-specific modalities versus a baseline without game-awareness. As demonstrated in FIGS. 7A-7F, the depicted implementations (a) capture samples from multiple basins of attraction: while it is likely that the solid line agent will turn first, as indicated by the majority of samples, it is still feasible that the dotted line agent will turn first. Indeed, the example implementation samples the solid line agent leading, while FPS and the vanilla model exhaust all six samples assuming that the dotted line agent will lead. Importantly, the example implementations cover multiple yield configurations without labeled maneuvers.

Quantitative results can be shown by the accuracy-coverage tradeoff in increasingly complex scenarios. Table 2 below details several ablations on the coverage loss coefficient λ₁. As 1λ₁ increases, coverage is increasingly emphasized over both accuracy and classification losses. As a result, the game-theoretic coverage term can be used in two ways. For small values of λ₁, accuracy (in the sense of minSFDE) increases. This may be because the model avoids sampling redundantly from the same basin of attraction. For larger values of λ₁, coverage increases dramatically at a minor expense of accuracy, likely due to over-emphasis of the target distribution in Eq. 14. A value of λ₁=10 provides both an increase in semantic coverage and good minSFDE.

TABLE 2

| λ₁ | min SADE ↓ | min SFDE ↓ | KL - Div ↓ | SC (yield) ↑ | SC (follow) ↑ | num(yield) ↑ | num(follow) ↑ |
|---|---|---|---|---|---|---|---|
| 0 | 2.330 | 5.587 | 0.1125 | 0.0715 | 0.2705 | 1.222 | 10.518 |
| 1 | 2.317 | 5.571 | 0.1048 | 0.1052 | 0.3661 | 1.519 | 11.905 |
| 5 | 2.326 | 5.549 | 0.0922 | 0.1267 | 0.3808 | 1.726 | 12.849 |
| 10 | 2.316 | 5.547 | 0.0849 | 0.1345 | 0.3558 | 1.758 | 13.163 |
| 20 | 2.339 | 5.609 | 0.0729 | 0.1419 | 0.3634 | 1.694 | 13.312 |
| 50 | 2.351 | 5.595 | 0.0613 | 0.1493 | 0.3918 | 1.562 | 12.918 |
| 100 | 2.343 | 5.572 | 0.0580 | 0.2128 | 0.5274 | 1.470 | 12.160 |

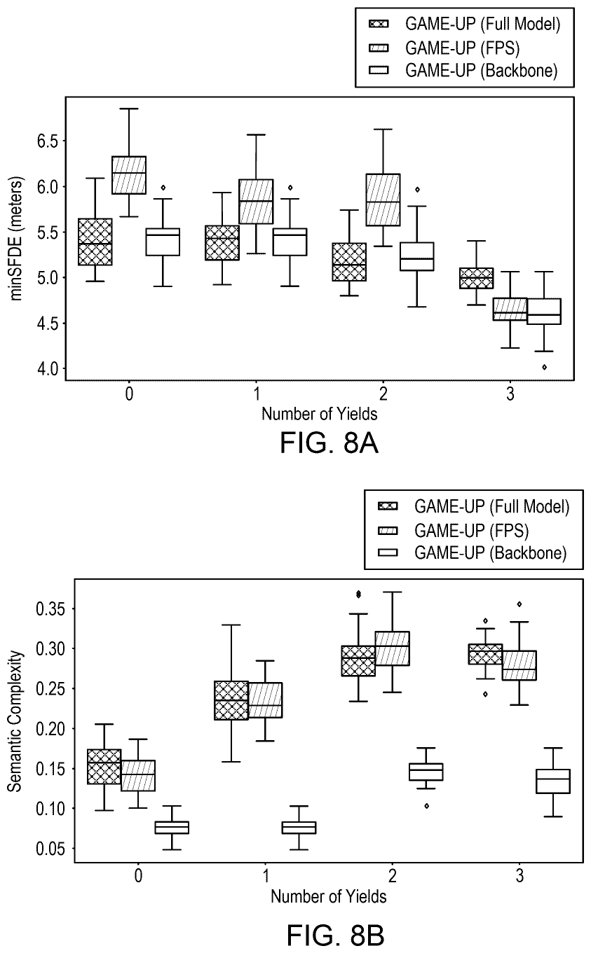

FIGS. 8A and 8B are box plots that show a tradeoff between accuracy and coverage as semantic complexity increases with the number of yield interactions for the experimental implementations disclosed herein. In FIG. 8A, Examples 1, 2, and 4 are shown offering similar accuracy, with-UP providing lower error on average until split Y=3. In FIG. 8B, Examples 1, 2, and 4 provide higher semantic coverage on splits except Y=2, although performance is similar. As shown in FIGS. 8A and 8B, the examples enjoy a highest overall performance on all splits when optimizing for a blend of accuracy and coverage.

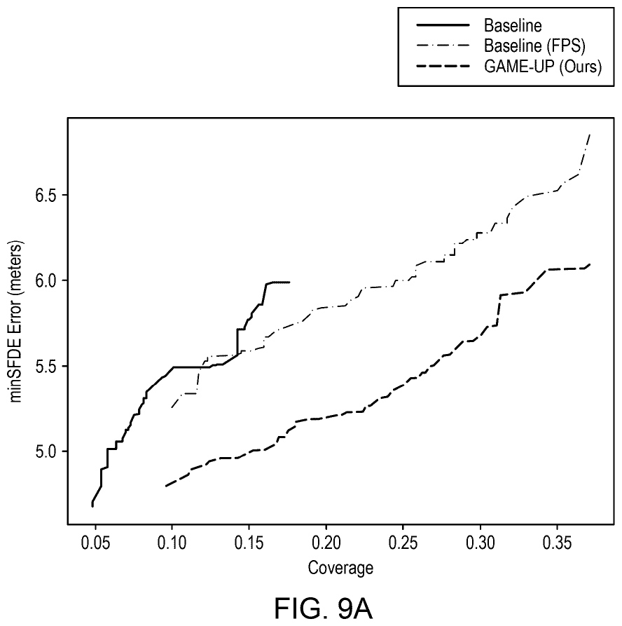

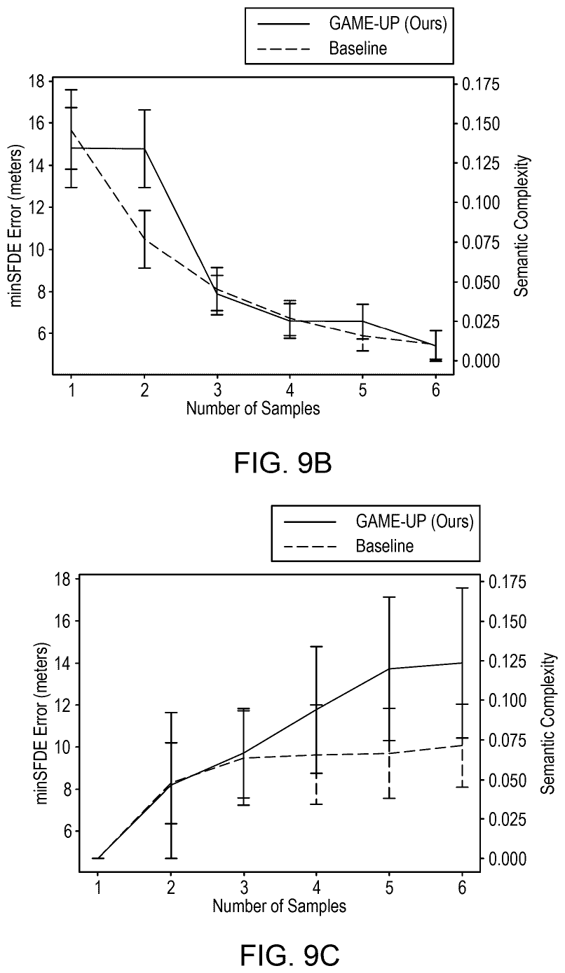

FIG. 9A illustrates an accuracy/coverage tradeoff where semantic complexity increases with the number of yield interactions. FIG. 9A provides coverage versus minSFDE (in meters) for embodiments disclosed herein (e.g., GAME-UP) versus baseline models. The baseline model achieves low error but rapidly drops in performance as the scenario complexity increases. While, the baseline model using FPS adds coverage of different semantic maneuvers (e.g. yielding), this model forfeits the some accuracy for this tradeoff. An example implementation of the disclosed embodiments, using a game-theoretic mode-finding model, enjoys the highest overall performance on all splits when optimizing for a blend of accuracy and coverage. For example, the embodiments disclosed herein achieves high coverage of semantic modes while preserving up to 12.5% percent less minSFDE.

Furthermore, each additional sample contributes to both accuracy and coverage, as shown in FIGS. 9B and 9C. More particularly, FIG. 9B shows minSFDE as the number of prediction samples increases for the full Example 4 and Example 1, and FIG. 9C shows Semantic Complexity as the number of prediction samples increases. As shown in FIGS. 9B and 9C, accuracy and semantic complexity vary together with relatively large deviations after the third and sixth samples, indicating that each new sample covers distinct modal equilibria. Results in improved coverage of semantic complexity for N≥3 samples can be obtained, with similar accuracy.

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines, or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various embodiments are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. This can include a processor, and/or any one or more of the components making up trajectory prediction system 300 of FIG. 3 and/or server 410, ego device 420, and/or agent device(s) 430 of FIG. 4. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. Media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, a cartridge, an optical disk, a CD, or a DVD. Storage media 1014 may be any other fixed or removable medium that is read by, written to, or accessed by media drive 1012. As these examples illustrate, storage media 1014 can include a computer usable storage medium having stored therein computer software or data.

In alternative embodiments, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component), and a memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or soft modem, a network interface (such as an Ethernet, a network interface card, an IEEE 802.XX, or other interface). Other examples include a communications port (such as for example, a USB port, an IR port, an RS232 port Bluetooth® interface, or other port), or other communications interface. Software/data transferred via communications interface 1024 may be carried on signals, which can be electronic, electromagnetic (which includes optical), or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1022, media 1014, and channel 1028. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable computing component 1000 to perform features or functions of the present application as discussed herein.

It should be understood that the various features, aspects, and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more,” or the like; and adjectives such as “conventional,” “traditional,” “normal,” “standard,” “known,” or terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for trajectory planning, the method comprising:
obtaining training data including first trajectories for a first plurality of agent devices and first map information of a first environment for a past time horizon;
applying the training data to a game-theoretic mode-finding algorithm to generate a mode-finding model for each agent device that predicts modes of the first trajectories;
training a trajectory prediction model on the predicted modes as a coverage loss term between predicted modes;
predicting future trajectories for a second plurality of agent devices based on applying observed data to the trajectory prediction model, wherein the observed data includes second trajectories for a second plurality of agent devices and second map information of a second environment; and
generating a control signal to effectuate an autonomous driving command on an agent device of the second plurality of agent devices based on the predicted future trajectories.

2. The method of claim 1, wherein the agent device of the second plurality of agent devices is a vehicle comprising an autonomous driving system.

3. The method of claim 1, further comprising:
generating joint trajectory proposals by perturbing the first trajectories, wherein each joint trajectory proposal comprises a perturbed first trajectory of each agent device of the plurality of agent devices;
providing the joint trajectory proposals as input to the game-theoretic mode-finding algorithm; and
outputting a number of weighted modes for each agent device of the first plurality of agent devices from the mode-finding model.

4. The method of claim 3, further comprising:
for each perturbed first trajectory for a respective agent device of the first plurality of agent devices, combining the respective perturbed first trajectory to a perturbed first trajectory of remaining first agent devices of the first plurality of agent devices to generate the joint trajectory proposals;
scoring each joint trajectory proposal based on similarity to the first trajectories;
identifying a local maximum score for the joint trajectory proposals; and
outputting the number of weighted modes for each agent based on the identified local maximum.

5. The method of claim 1, further comprising:
applying the training data to a machine learning reward algorithm to generate a reward model for each agent device,
wherein generating the mode-finding model for each agent device is based on providing the reward models to the game-theoretic mode-finding algorithm.

6. The method of claim 5, further comprising:
computing trajectory variations for each of the first trajectories; and
assigning a reward to each trajectory variation and each of the first trajectories, wherein the rewards are assigned to encourage each of the first trajectories.

7. The method of claim 5, wherein the machine learning reward algorithm comprises an inverse reinforcement learning (IRL) algorithm.

8. The method of claim 1, wherein the game-theoretic mode-finding algorithm comprises a local optimization algorithm to enumerate modes.

9. A system, comprising:
a memory configured to store instructions; and
one or more processors communicably coupled to the memory and configured to execute the instructions to:
obtain training data including first trajectories for a first plurality of agent devices and first map information of a first environment for a past time horizon;
train a trajectory prediction model on modes of the first trajectories predicted by a mode-finding model trained by applying the training data to a game-theoretic mode-finding algorithm;
predict trajectories for a second plurality of agent devices based on applying observed data to the trajectory prediction model, wherein the observed data includes second trajectories for a second plurality of agent devices and second map information of a second environment; and
generate a control signal to effectuate an autonomous driving command on an agent device of the second plurality of agent devices based on the predicted trajectories.

10. The system of claim 9, wherein the agent device of the second plurality of agent devices is a vehicle comprising an autonomous driving system.

11. The system of claim 9, wherein the one or more processors are further configured to execute the instructions to:
generate joint trajectory proposals by perturbing the first trajectories, wherein each joint trajectory proposal comprises a perturbed first trajectory of each agent device of the plurality of agent devices;
provide the joint trajectory proposals as input to the game-theoretic mode-finding algorithm; and
output a number of weighted modes for each agent device of the first plurality of agent devices from the mode-finding model.

12. The system of claim 11, wherein the one or more processors are further configured to execute the instructions to:
for each perturbed first trajectory for a respective agent device of the first plurality of agent devices, combine the respective perturbed first trajectory to a perturbed first trajectory of remaining first agent devices of the first plurality of agent devices to generate the joint trajectory proposals;
score each joint trajectory proposal based on similarity to the first trajectories;
identify a local maximum score for the joint trajectory proposals; and
output the number of weighted modes for each agent based on the identified local maximum.

13. The system of claim 9, wherein the one or more processors are further configured to execute the instructions to:
apply the training data to a machine learning reward algorithm to generate a reward model for each agent device,
wherein generating the mode-finding model for each agent device is based on providing the reward models to the game-theoretic mode-finding algorithm.

14. The system of claim 13, wherein the one or more processors are further configured to execute the instructions to:
compute trajectory variations for each of the first trajectories; and
assign a reward to each trajectory variation and each of the first trajectories, wherein the rewards are assigned to encourage each of the first trajectories.

15. The system of claim 13, wherein the machine learning reward algorithm comprises an inverse reinforcement learning (IRL) algorithm.

16. The system of claim 9, wherein the game-theoretic mode-finding algorithm comprises a local optimization algorithm to enumerate modes.

17. A non-transitory computer-readable storage medium including instructions that, when executed by at least one processor of a computing system, cause the computing system to perform a method comprising:
collecting observed trajectories for a plurality of agent devices and map information of an environment;
predicting future trajectories for the plurality of agent devices based on weighted modes output by a game-theoretic mode-finding model trained to detect modes as groups of trajectories and assign weights to each mode; and
generating an autonomous driving command for controlling an agent device of the plurality of agent devices based on the predicted future trajectories.

18. The non-transitory computer-readable storage medium of claim 17, wherein the agent device is a vehicle comprising an autonomous driving system.

19. The non-transitory computer-readable storage medium of claim 17, wherein the game-theoretic mode-finding model is trained by predicting modes from a plurality of training trajectories from a past time horizon and applying a coverage loss term between the predicted modes.

20. The non-transitory computer-readable storage medium of claim 19, the game-theoretic mode-finding model is trained by predicting modes from map information of a first environment from the past time horizon.
